(19) United States
(12) Patent Application Publication
(10) Pub. No.: US 2019/0090080 A1
(43) Pub. Date: Mar. 21, 2019

(54) SYSTEM AND METHOD FOR DYNAMICALLY ADDING CAPABILITIES OF SENSORS AND ACTUATORS TO CLOUD DRIVER

(71) Applicant: American Megatrends, Inc., Norcross, GA (US)

(72) Inventors: Chandrasekar Rathineswaran, Cumming, GA (US); Joseprabu Inbaraj, Suwanee, GA (US)

(21) Appl. No.: 15/707,402

(22) Filed: Sep. 18, 2017

(51) Int. Cl. H04W 4/00; G06F 9/44; H04L 29/08; G06F 9/50

(52) U.S. Cl. CPC H04W 4/006; G06F 9/5072; H04L 67/125; G06F 9/4411

(57) ABSTRACT

Systems and methods for dynamically adding capabilities of an internet-of-things (IoT) device to a cloud driver. The cloud driver is provided at a cloud network, which is communicatively connected to the IoT device. A manufacturer or a vendor of the IoT device may define the capabilities of the IoT device in a human readable template format, such as a JavaScript Object Notation (JSON) Schema format, and send the capabilities of the IoT device in the human readable template format to the cloud driver at the cloud network. When the cloud driver receives the capabilities of the IoT device in the human readable template format, the cloud driver may store the capabilities of the IoT device in the human readable template format. Thus, an end user of the IoT device may access the capabilities of the IoT device stored on the cloud driver.

### FIELD

The present disclosure relates generally to Internet of Things (IoT) technology, and more particularly to systems and methods for dynamically adding capabilities of sensors and actuators to a cloud driver.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internet of things (IoT) is a relatively new developing technology. Specifically, IoT technology involves inter-networking of physical devices, vehicles, buildings, and other items, which may be embedded with electronics, software, sensors, actuators, and network connectivity that enable these objects to collect and exchange data. Generally, the sensors and actuators used in the IoT devices may be provided by different vendors or manufacturers. Since there is no existing standard for the vendors or manufacturers to define and share the capabilities of the sensors and actuators, an end-user may have difficulties to know the capabilities of each sensor or actuator. This is particularly important for the sensors and actuators that provide special capabilities that are not commonly defined.

Therefore, an unaddressed need exists in the art to address the aforementioned deficiencies and inadequacies.

### SUMMARY

Certain aspects of the disclosure direct to a system, which includes an internet-of-things (IoT) device having a plurality of capabilities, and a cloud driver provided at a cloud network. The IoT device is configured to be communicatively connected to the cloud driver at the cloud network. The cloud driver is configured to: receive the capabilities of the IoT device in a human readable template format; and store the capabilities of the IoT device in the human readable template format, such that the capabilities of the IoT device is accessible to an end user of the IoT device.

In certain embodiments, the system further includes a computing device communicatively connected to the cloud driver at the cloud network. The computing device is configured to: define the capabilities of the IoT device in the human readable template format; and send the capabilities of the IoT device in the human readable template format from the computing device to the cloud driver at the cloud network, such that the capabilities of the IoT device in the human readable template format are added in the cloud driver to be accessible to an end user of the IoT device.

Certain aspects of the disclosure direct to a method for dynamically adding capabilities of an internet-of-things (IoT) device to a cloud driver. In certain embodiments, the method includes: providing a cloud driver at a cloud network, wherein the IoT device is configured to be communicatively connected to the cloud driver at the cloud network; receiving, by the cloud driver, capabilities of the IoT device in a human readable template format; and storing, by the cloud driver, the capabilities of the IoT device in the human readable template format, such that the capabilities of the IoT device is accessible to an end user of the IoT device.

In certain embodiments, the capabilities of the IoT device is defined in the human readable template format at a computing device, and sent by the computing device to the cloud driver at the cloud network.

In certain embodiments, the computing device is configured to be operated by a manufacturer or a vendor of the IoT device.

Certain aspects of the disclosure direct to a method for dynamically adding capabilities of an internet-of-things (IoT) device to a cloud driver. In certain embodiments, the method includes: providing the IoT device, wherein the IoT device is configured to provide a plurality of capabilities; defining, at a computing device, the capabilities of the IoT device in a human readable template format; and sending the capabilities of the IoT device in the human readable template format from the computing device to a cloud driver at a cloud network, such that the capabilities of the IoT device in the human readable template format are added in the cloud driver to be accessible to an end user of the IoT device.

In certain embodiments, the human-readable template format is a JavaScript Object Notation (JSON) Schema format.

In certain embodiments, the IoT device includes a sensor, and the capabilities of the sensor include: a triggering condition; and an event triggered by the triggering condition.

In certain embodiments, the IoT device includes an actuator, and the capabilities of the actuator include at least one action.

In certain embodiments, the cloud driver is further configured to remotely communicate with the IoT device based on the capabilities of the IoT device, and communication between the cloud driver and the IoT device is in a format different from the human-readable template format.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1 schematically depicts an exemplary system according to certain embodiments of the present disclosure.

FIG. 2 depicts a flowchart of the method for dynamically adding capabilities of an IoT device to a cloud driver according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

Certain embodiments of the present disclosure relate to computer technology. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Certain aspects of the present disclosure direct to systems and methods for dynamically adding capabilities of an internet-of-things (IoT) device to a cloud driver. The systems and methods provide an easier way for any new vendors or manufacturers of the IoT device, which may include a sensor or an actuator, to define and publish the capabilities to the cloud driver. In certain embodiments, the capabilities of the IoT device may be defined in a human readable template format, such as a JavaScript Object Notation (JSON) Schema format. In this case, the published capabilities are dynamically visible to end users of the IoT device, and can be instantly used in the design flow.

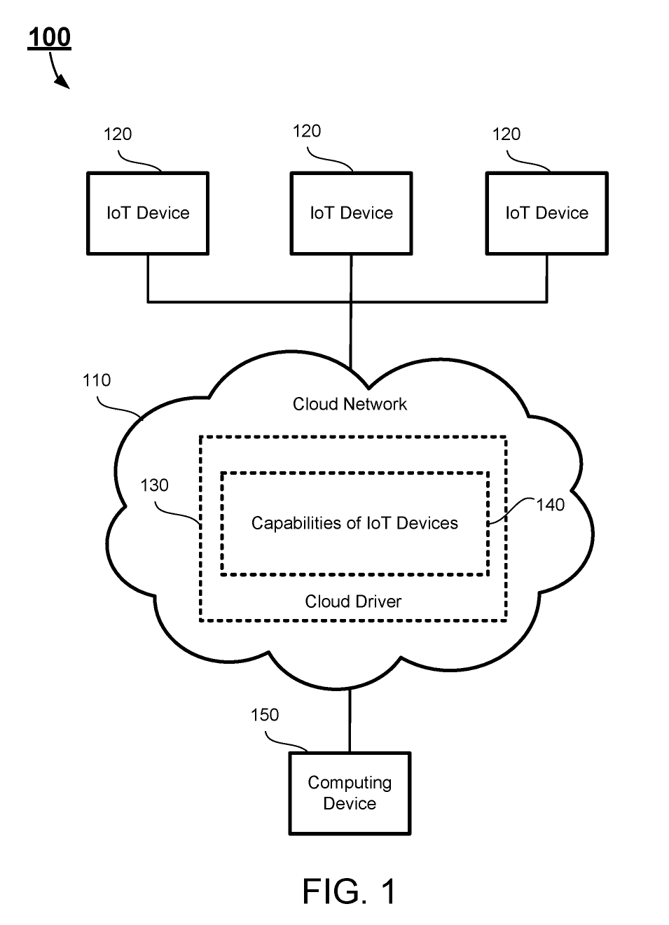

FIG. 1 schematically depicts an exemplary system according to certain embodiments of the present disclosure. As shown in FIG. 1, the system 100 includes a cloud network 110, which utilizes multiple computing resources to provide a cloud driver 130. As shown in FIG. 1, a plurality of IoT devices 120 are respectively communicatively connected to the cloud network 110, and the cloud driver 130 stores a copy of the capabilities 140 of the IoT devices 120. Optionally, the system 100 may further include a computing device 150, which is communicatively connected to the cloud network 110, such that a user (such as a manufacturer or a vendor of one of the IoT devices 120, or an end user of one of the IoT devices 120) may remotely connect to the cloud driver 130 at the cloud network 110 to access the capabilities 140.

The cloud network 110 is an Internet-based network that provides shared computing resources (e.g., processors, memory, storage devices, network interfaces) and data on demand. In certain embodiments, the cloud network 110 includes a shared pool of configurable computing resources. Examples of the configurable computing resources may include, without being limited thereto, a plurality of networks, servers, computing devices, processors, storage devices, applications, services, or other hardware and/or software components. In certain embodiments, the cloud network 110 utilizes the computing resources to execute the cloud driver 130, such that the capabilities 140 stored in the cloud driver 130 is accessible by the user of the IoT devices 120. In certain embodiments, the cloud network 110 may be a private cloud network or a public cloud network, and may be of various forms.

Each of the IoT devices 120 is a device with IoT functionalities, which communicates with the cloud driver 130 at the cloud network 110 to provide certain capabilities. Generally, the capabilities of the IoT devices 120 may be different based on the type of the IoT devices 120. In certain embodiments, the IoT device 120 may include a sensor, and the capabilities of the sensor include: a triggering condition; and an event triggered by the triggering condition. For example, the IoT device 120 may include a temperature sensor, which may use a designated temperature as the triggering condition. When the temperature sensor detects that the environmental temperature reaches the designated temperature, the temperature sensor generates an event triggered by the designated temperature (i.e., the triggering condition). In certain embodiments, the IoT device 120 may include an actuator, and the capabilities of the actuator include at least one action. For example, the IoT device 120 may include a switch as an actuator, which may be switched between two actions, including an ON action and an OFF action. In certain embodiments, the IoT device 120 may be a complex device formed by one or more sensors and/or one or more actuators. In this case, the capabilities of the sensors and actuators may be interactive. For example, the event generated by one sensor may be used to trigger an action of one actuator, and the action of another actuator may create a triggering condition of another sensor.

The cloud driver 130 is a software agent that may be communicate with the IoT device based on the capabilities of the IoT device. In certain embodiments, the cloud driver 130 is designed to be capable of understanding and interpreting data in the human readable template format. For example, the JSON Schema format may be used as the human readable template format. JSON Schema is a vocabulary which is clear and readable by human and machines, that allows a user to annotate and validate JSON documents. When JSON Schema is used, the cloud driver 130 may receive and store the capabilities of the IoT devices 120 in the JSON Schema format, such that the capabilities of the IoT devices 120 becomes accessible by the end users of the IoT devices 120.

The computing device 150 is a computing device that a user (e.g., a manufacturer or a vendor of one of the IoT devices 120, or an end user of one of the IoT devices 120) may operate to communicate with the cloud driver 130 at the cloud network 110. In certain embodiments, the manufacturer or the vendor of one of the IoT devices 120 may operate the computing device 150 to define the capabilities of the IoT device 120 in the human readable template format (e.g., the JSON Schema format), and send the capabilities of the IoT device 120 in the human readable template format to the cloud driver 130. In certain embodiments, an end user of one of the IoT devices 120 may access the cloud driver 130 to read and understand the capabilities of the IoT device 120 stored in the cloud driver 130. In certain embodiments, the computing device 150 may include necessary computer resources, such as a processor, a memory, a storage device, network interface, or other hardware components and software components (not shown) to perform its corresponding tasks. Examples of these hardware and software components of the computing device 150 may include, but not limited to, other required memory, interfaces, buses, Input/Output (I/O) modules and peripheral devices.

It should be noted that, as shown in FIG. 1, the computing device 150 is an independent computer separated from the IoT devices 120. In other words, the computing device 150 may not be a part of the IoT system formed by the IoT devices 120. In certain embodiments, however, the computing device 150 may be communicatively connected to one or more of the IoT devices 120, forming an IoT system. In this case, the computing device 150 is a part of the IoT system.

In certain embodiments, the system 100 may include multiple IoT devices 120 and multiple computing devices 150, which may be simultaneously communicatively connected to the cloud driver 130 at the cloud network 110. Thus, the cloud driver 130 may implement other mechanisms to ensure the safety of the data stored in the cloud driver 130, such as the capabilities 140 of the IoT devices 120.

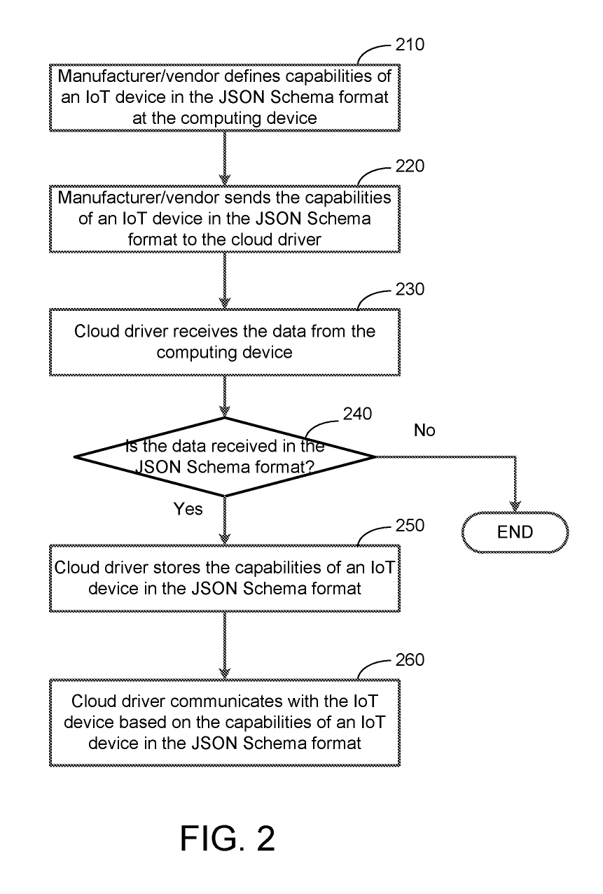

FIG. 2 depicts a flowchart of the method for dynamically adding capabilities of an IoT device to a cloud driver according to certain embodiments of the present disclosure. In certain embodiments, the method as shown in FIG. 2 may be implemented by a system as shown in FIG. 1 for dynamically adding capabilities of an IoT device 120 to a cloud driver 130. In certain embodiments, the method may be implemented by the cloud driver 130 at the cloud network 110 of the system 100 as shown in FIG. 1. It should be particularly noted that, unless otherwise stated in the present disclosure, the steps of the method may be arranged in a different sequential order, and are thus not limited to the sequential order as shown in FIG. 2.

As shown in FIG. 2, at procedure 210, a manufacturer or a vendor of an IoT device 120 may define the capabilities of the IoT device 120 in the JSON Schema format (which is the human readable template format used by the cloud driver 130) at the computing device 150. At procedure 220, the manufacturer/vendor may send the capabilities of the IoT device 120 in the JSON Schema format to the cloud driver 130. At procedure 230, the cloud driver 130 receives the data from the computing device 150. Since the cloud driver 130 uses the JSON Schema format as the human readable template format, at procedure 240, the cloud driver 130 checks whether the data received from the computing device 150 is in the JSON Schema format. If the data received from the computing device 150 is not in the JSON Schema format, the cloud driver 130 ends the process. On the other hand, if the data received from the computing device 150 is in the JSON Schema format, the cloud driver 130 stores the capabilities 140 of the IoT device 120 in the JSON Schema format. In this case, the capabilities 140 of the IoT device 120 stored at the cloud driver 130 may be accessible by the end user of the IoT device 120. At procedure 260, the cloud driver 130 may further remotely communicate with the IoT device 120 based on the capabilities 140 of the IoT device 120.

It should be particularly noted that, although the capabilities 140 of the IoT device 120 stored at the cloud driver 130 is in the human readable template format (e.g., the JSON Schema format), the actual communication between the cloud driver 130 and the IoT device 120 may be in a different format from the human-readable template format. For example, communication between the cloud driver 130 and the IoT device 120 may utilize a format which is not human readable, such that the data size of the communication may be reduced.

By utilizing the system and method as described above, the cloud driver 130 may be used to store and publish the capabilities of the IoT devices 120, which may be defined in the human readable template format, allowing the end user to understand the capabilities of the IoT devices 120 by accessing the capabilities 140 at the cloud driver 130. In this case, any new manufacturer or vendor that provides a new IoT device may follow the protocol by defining the capabilities of the new IoT device in the human readable template format, and uploading the capabilities of the new IoT device in the human readable template format to the cloud driver 130 for publication.

In a further aspect, the present disclosure is related to a non-transitory computer readable medium storing computer executable code. The code, when executed at a processer of a controller, may perform the method as described above. In certain embodiments, the non-transitory computer readable medium may include, but not limited to, any physical or virtual storage media storing the cloud driver 130 at the cloud network 110 as shown in FIG. 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A system, comprising:
an internet-of-things (IoT) device having a plurality of capabilities;
a cloud driver provided at a cloud network, wherein the IoT device is configured to be communicatively connected to the cloud driver at the cloud network, wherein the cloud driver is configured to
receive the capabilities of the IoT device in a human readable template format; and
store the capabilities of the IoT device in the human readable template format, such that the capabilities of the IoT device is accessible to an end user of the IoT device.

2. The system of claim 1, further comprising a computing device communicatively connected to the cloud driver at the cloud network, wherein the computing device is configured to:
define the capabilities of the IoT device in the human readable template format; and
send the capabilities of the IoT device in the human readable template format from the computing device to the cloud driver at the cloud network, such that the capabilities of the IoT device in the human readable template format are added in the cloud driver to be accessible to an end user of the IoT device.

3. The system of claim 2, wherein the human-readable template format is a JavaScript Object Notation (JSON) Schema format.

4. The system of claim 2, wherein the computing device is configured to be operated by a manufacturer or a vendor of the IoT device.

5. The system of claim 1, wherein the IoT device comprises a sensor, and the capabilities of the sensor comprise:
a triggering condition; and
an event triggered by the triggering condition.

6. The system of claim 1, wherein the IoT device comprises a actuator, and the capabilities of the actuator comprise at least one action.

7. The system of claim 1, wherein the cloud driver is further configured to remotely communicate with the IoT device based on the capabilities of the IoT device, and communication between the cloud driver and the IoT device is in a format different from the human-readable template format.

8. A method for dynamically adding capabilities of an internet-of-things (IoT) device to a cloud driver, comprising:
providing a cloud driver at a cloud network, wherein the IoT device is configured to be communicatively connected to the cloud driver at the cloud network;
receiving, by the cloud driver, capabilities of the IoT device in a human readable template format; and
storing, by the cloud driver, the capabilities of the IoT device in the human readable template format, such that the capabilities of the IoT device is accessible to an end user of the IoT device.

9. The method of claim 8, wherein the capabilities of the IoT device is defined in the human readable template format at a computing device, and sent by the computing device to the cloud driver at the cloud network.

10. The method of claim 9, wherein the computing device is configured to be operated by a manufacturer or a vendor of the IoT device.

11. The method of claim 8, wherein the human-readable template format is a JavaScript Object Notation (JSON) Schema format.

12. The method of claim 8, wherein the IoT device comprises a sensor, and the capabilities of the sensor comprise:
a triggering condition; and
an event triggered by the triggering condition.

13. The method of claim 8, wherein the IoT device comprises a actuator, and the capabilities of the actuator comprise at least one action.

14. The method of claim 8, wherein the cloud driver is further configured to remotely communicate with the IoT device based on the capabilities of the IoT device, and communication between the cloud driver and the IoT device is in a format different from the human-readable template format.

15. A method for dynamically adding capabilities of an internet-of-things (IoT) device to a cloud driver, comprising:
providing the IoT device, wherein the IoT device is configured to provide a plurality of capabilities;
defining, at a computing device, the capabilities of the IoT device in a human readable template format;
sending the capabilities of the IoT device in the human readable template format from the computing device to a cloud driver at a cloud network, such that the capabilities of the IoT device in the human readable template format are added in the cloud driver to be accessible to an end user of the IoT device.

16. The method of claim 15, wherein the human-readable template format is a JavaScript Object Notation (JSON) Schema format.

17. The method of claim 15, wherein the IoT device comprises a sensor, and the capabilities of the sensor comprise:
a triggering condition; and
an event triggered by the triggering condition.

18. The method of claim 15, wherein the IoT device comprises a actuator, and the capabilities of the actuator comprise at least one action.

19. The method of claim 15, wherein the IoT device is configured to be communicatively connected to the cloud driver at the cloud network.

20. The method of claim 19, wherein the cloud driver is further configured to remotely communicate with the IoT device based on the capabilities of the IoT device, and communication between the cloud driver and the IoT device is in a format different from the human-readable template format.
